(19) United States
(12) Patent Application Publication
(10) Pub. No.: US 2008/0231693 A1
(43) Pub. Date: Sep. 25, 2008

(54) OPTICAL DEVICE, CAMERA MODULE, MOBILE PHONE, DIGITAL STILL CAMERA, AND MEDICAL ENDOSCOPE

(76) Inventor: Yoshiki TAKAYAMA, Shiga (JP)

Correspondence Address: MCDERMOTT WILL & EMERY LLP, 600 13TH STREET, NW, WASHINGTON, DC, 20005-3096, US

(21) Appl. No.: 12/045,535

(22) Filed: Mar. 10, 2008

(30) Foreign Application Priority Data
Mar. 22, 2007 (JP) 2007-074981

(51) Int. Cl. H04N 7/18; H04N 5/225; H04M 1/00

(52) U.S. Cl. 348/65; 348/340; 348/220.1; 455/556.1; 348/E05.024; 348/E07.085

(57) ABSTRACT

An optical device includes an optical element and a transparent element. The optical element includes an image pickup region provided on a main surface of a semiconductor substrate for outputting a signal according to incident light, a peripheral circuit region provided around the image pickup region for transmitting a signal received from the image pickup region, and an electrode pad provided on a part of an edge of the main surface of the semiconductor substrate for outputting a signal transmitted through the peripheral circuit region. The transparent member is bonded to the semiconductor substrate so that the transparent member covers the image pickup region and that an end face of the transparent member is located between the electrode pad and the image pickup region when viewed two-dimensionally. The transparent member is positioned so that a distance between the end face and the image pickup region is 0.04 mm or more.

### BACKGROUND OF THE INVENTION

1. Field of the Invention

The invention relates to an optical device, a camera module, a mobile phone, a digital still camera, and a medical endoscope.

2. Related Art

With recent improvement in reduction in size, thickness, and weight of electronic equipments, high density packaging of semiconductor devices has been increasingly demanded. With this high density packaging and high integration resulting from the improved microfabrication technology, so-called chip mounting technology has been proposed. The chip mounting technology is a technology of mounting a chip-size package or a bare chip semiconductor element directly onto a substrate. Such a trend has also been seen in optical devices, and various structures of the optical devices have been proposed.

For example, Japanese Laid-Open Patent Publication No. 2003-31782 describes an element structure and a manufacturing method of a solid-state image pickup device. According to this publication, reduction in size, thickness, and cost of the solid-state image pickup device is implemented by bonding a transparent member directly onto a microlens provided on an image pickup region of a solid-state image pickup element by using a low refractive index adhesive. More specifically, according to the publication, since the transparent member is bonded directly to the solid-state image pickup element and the area to which the transparent member is to be bonded is not required, a smaller, thinner solid-state image pickup device can be implemented at lower cost as compared to a solid-state image pickup device having a recessed hollow structure.

### SUMMARY OF THE INVENTION

In the above structure, however, the overall size of the transparent member with respect to the image pickup region is significantly small as compared to a solid-state image pickup device having a recessed hollow structure. Therefore, the conventional solid-state image pickup device of the above structure may have defects as follows: for example, chippings of the outer periphery of the transparent member may affect an image, or a defective image may be generated due to an insufficient incident area for external light. Moreover, since electrode pads are formed on the same plane as the image pickup plane of the solid-state image pickup element, an adhesive for bonding the transparent member may overflow onto the electrode pads, which may cause defective connection of wire bonding. The conventional solid-state image pickup device having the above structure thus has problems in quality such as generation of a defective image and defective wire bonding.

The invention is made in view of the above problems, and it is an object of the invention to provide a small, low-cost optical device in which defects such as generation of a defective image are suppressed, and a camera module, mobile phone, digital still camera, and medical endoscope including the optical device.

In order to solve the above problems, an optical device according to the invention includes an optical element and a transparent member. The optical element includes a semiconductor substrate, an image pickup region provided on a main surface of the semiconductor substrate for outputting a signal according to incident light, a peripheral circuit region provided around the image pickup region for transmitting a signal received from the image pickup region, and a pad provided on a part of an edge of the main surface of the semiconductor substrate for outputting a signal transmitted through the peripheral circuit region. The transparent member is bonded to the semiconductor substrate so that the transparent member covers the image pickup region and that an end face of the transparent member is located between the pad and the image pickup region when viewed two-dimensionally. A distance between the end face and the image pickup region is 0.04 mm or more.

In the above optical device, the transparent member is formed so as to cover the image pickup region, and the transparent member is bonded to the semiconductor substrate so that the end face of the transparent member is located at least 0.04 mm away from the image pickup region. This structure prevents chippings of the outer periphery of the transparent member from affecting an image and therefore suppresses generation of a defective image. As a result, a smaller optical device with higher image quality than the conventional device can be implemented.

The reason why the distance between the end face of the transparent member and the image pickup region is 0.04 mm or more will now be described. It is now assumed that the minimum chipping amount (a) of the transparent member is 0.03 mm, the minimum thickness (b) of the transparent member made of, e.g., glass is 0.2 mm, the minimum incident angle (c) of light that is incident from outside to the transparent member is 5°, the refractive index n2 of the transparent member is 1.5, and the refractive index n1 of air is 1. In the case where the minimum value of the assembly tolerance of the member is an ideal value (zero), the incident angle θ2 to the transparent member is θ2=3.331° by the formula sin θ2=(n1·sin θ1/n2) according to Snell's law. The dimensions of the transparent member that are required for incident light on the transparent member to reach the image pickup region are obtained from the above values. Of the transparent member formed so as to cover the image pickup region, a portion that does not overlap the image pickup region when viewed two-dimensionally is tan θ2·b=0.012 mm. In view of the minimum chipping amount (a) of the transparent member, the portion that does not overlap the image pickup region when viewed two-dimensionally is 0.012+a=0.042 mm. 0.042 mm is rounded down to 0.04 mm in view of processing accuracy of the transparent member. Generation of a defective image due to the influence of the transparent member can thus be suppressed in the case where the distance between the end face of the transparent member and the image pickup region is 0.04 mm or more.

Preferably, a distance between the end face of the transparent member and an end face of the semiconductor substrate is 0.02 mm or more. In this case, the influence of chippings of the semiconductor substrate produced in a dicing step is reduced, and a higher quality image can be provided.

The optical device of the invention may further include a transparent adhesive layer for bonding the semiconductor substrate to the transparent member. Preferably, the optical device further includes a wiring substrate provided under the semiconductor substrate, and a thin metal wire for electrically connecting the pad to the wiring substrate, and a distance between the end face of the transparent member and the pad is preferably 0.01 mm or more.

In this structure, the transparent member is provided also in view of the distance to the pad. Therefore, the transparent adhesive layer can be prevented from being formed on the pad as an electrode when the transparent member is bonded to the semiconductor substrate. Accordingly, in a wire bonding step for connecting the electrode pad to a wiring of an external circuit, for example, the optical device can be relatively easily mounted on a circuit substrate while reducing generation of defective connection.

The reason why the distance between the end face of the transparent member and the pad is 0.01 mm or more will be described. It is herein assumed that the transparent member and the semiconductor substrate are bonded together by an adhesive, the thickness (d) of the transparent adhesive layer is 0.01 mm, an overflow portion of the adhesive is tapered from the bottom surface of the transparent member to the main surface of the semiconductor substrate, and the taper angle θ3 is 45 degrees. In this case, the minimum value of the overflow size of the adhesive is tan θ3·d=0.01 mm. Therefore, when the distance between the end face of the transparent member and the pad is 0.01 mm or more, the adhesive for bonding the transparent member can be prevented from overflowing onto the electrode pad, whereby generation of defective connection in the wire bonding step can be suppressed.

The optical device of the invention is also used in a camera module, a mobile phone, a digital still camera, and a medical endoscope. Since these equipments have an optical device having the above effects, reduction in size of the equipments can be implemented while maintaining excellent quality.

### BRIEF DESCRIPTION OF THE DRAWINGS

FIG. 1A is a top view of the structure of a solid-state image pickup device according to a first embodiment of the invention, FIG. 1B is a cross-sectional view taken along line Ib-Ib in FIG. 1A, and FIG. 1C is a cross-sectional view taken along line Ic-Ic in FIG. 1A;

FIG. 2 is a cross-sectional view of a package structure of the solid-state image pickup device according to the first embodiment of the invention;

FIG. 3A is a top view of the structure of a solid-state image pickup device according to a second embodiment of the invention, and FIG. 3B is a cross-sectional view taken along line IIIb-IIIb in FIG. 3A; and

FIG. 4A is a cross-sectional view of a camera module having the solid-state image pickup device of the second embodiment mounted thereon, FIG. 4B is a cross-sectional view of a medical endoscope camera module having the solid-state image pickup device of the second embodiment mounted thereon, and FIG. 4C is a cross-sectional view of a package structure of the solid-state image pickup device according to the second embodiment of the invention.

### DESCRIPTION OF THE PREFERRED EMBODIMENTS

Hereinafter, embodiments of the invention will be described with reference to the accompanying drawings. Note that the drawings are schematic drawings, and the dimensions and the number of members shown in the figures are different from those in an actual device. In the following embodiments, a solid-state image pickup device is described as an example of an optical device.

### First Embodiment

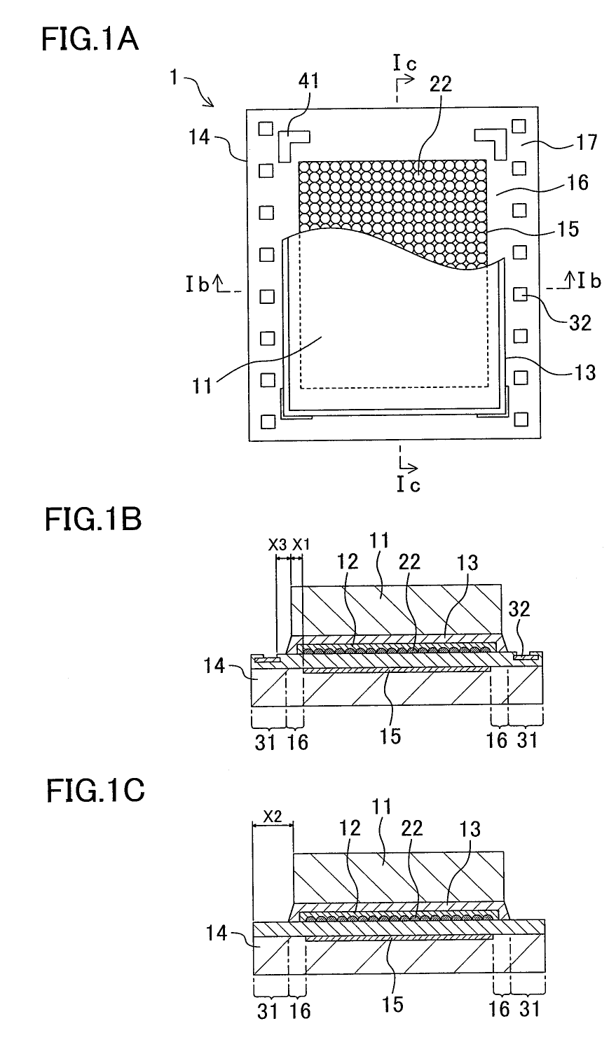

Hereinafter, the structure of a solid-state image pickup device 1 according to a first embodiment of the invention will be described with reference to FIGS. 1A through 1C. FIG. 1A is a top view of the structure of a solid-state image pickup device 1 according to the first embodiment. FIG. 1B is a cross-sectional view taken along line Ib-Ib in FIG. 1A, and FIG. 1C is a cross-sectional view taken along line Ic-Ic in FIG. 1A.

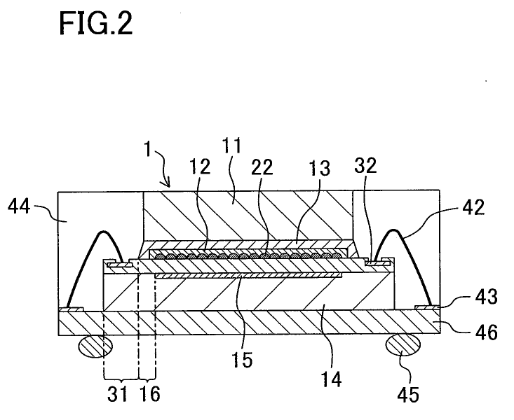

As shown in FIGS. 1A through 1C, the solid-state image pickup device 1 of this embodiment includes a solid-state image pickup element. The solid-state image pickup element includes a semiconductor substrate 14, an image pickup region 15, a microlens 22, a peripheral circuit region 16, and a plurality of electrode pads 32. The image pickup region 15 is provided on a main surface of the semiconductor substrate 14 and outputs a signal according to incident light. The microlens 22 is provided over the image pickup region 15 and collects external light onto the image pickup region 15. The peripheral circuit region 16 is provided around the image pickup region 15 and transmits a signal received from the image pickup region 15 to an external circuit. The plurality of electrode pads 32 are provided in a terminal region 31 and output a signal transmitted through the peripheral circuit region 16 to the external circuit. The solid-state image pickup device 1 further includes a low refractive index layer 12, a transparent member 11, and a transparent adhesive layer 13. The low refractive index layer 12 is provided on the microlens 22 so as to cover the image pickup region 15, and is made of a material having a lower refractive index than the microlens 22. The transparent member 11 is provided over the low refractive index layer 12 so as to cover the image pickup region 15. The transparent adhesive layer 13 bonds the semiconductor substrate 14 and the low refractive index layer 12 with the transparent member 11. Note that after the solid-state image pickup device 1 is mounted on a mounting substrate or a package, each electrode pad 32 provided at the end of each wiring in the terminal region 32 is connected to, e.g., a land of the mounting substrate or an inner lead of the package through a thin metal wire (see FIG. 2).

As shown in FIG. 1B, the transparent member 11 is formed so that the end face of the transparent member 11 is located between the image pickup region 15 and the electrode pad 32 when viewed two-dimensionally. The distance X1 between the end face of the transparent member 11 and the image pickup region 15 is 0.04 mm or more, and the distance X3 between the end face of the transparent member 11 and the electrode pad 32 is 0.01 mm or more. As shown in FIG. 1C, on the sides where the electrode pads 32 are not provided on the main surface of the semiconductor substrate, the distance X2 between the end face of the transparent substrate 1 and the end face of the semiconductor substrate 14 is 0.02 mm or more. As shown in FIG. 1A, a mark 41, for example, is formed over the main surface of the semiconductor substrate 14 in order to position the transparent member 11 at a prescribed location in view of these dimensions.

The solid-state image pickup device 1 of this embodiment is characterized in that the transparent member 11 is formed so as to cover the image pickup region 15 and in that the transparent member 11 is bonded to the semiconductor substrate 14 so that the end face of the transparent member 11 is located at least 0.04 mm away from the image pickup region 15. This structure prevents chippings of the outer periphery of the transparent member 11 from affecting an image and therefore suppresses generation of a defective image. As a result, a smaller solid-state image pickup device with higher image quality than the conventional device can be implemented.

In the solid-state image pickup device 1 of this embodiment, the transparent member 11 is provided also in view of the distance to the electrode pads 32. Therefore, the transparent adhesive layer 13 can be prevented from being formed on the electrode pads 32 when the transparent member 11 is bonded to the semiconductor substrate 14. Accordingly, in a wire bonding step for connecting the electrode pads 32 to wirings of an external circuit, for example, the solid-state image pickup device can be relatively easily mounted on a circuit substrate while reducing generation of defective connection.

On the sides where the electrode pads 32 are not provided in the semiconductor substrate 14, the transparent member 11 is provided at least 0.02 nm away from the end face of the semiconductor substrate 14. Therefore, the transparent adhesive layer 13 for bonding the transparent member 11 is less likely to be affected by chippings of the semiconductor substrate 14 produced in a dicing step. As a result, an optical device capable of providing a higher quality image can be implemented.

In the solid-state image pickup device 1 of this embodiment, the mark 41 for positioning the transparent member 11 is formed over the semiconductor substrate 14. This enables the transparent substrate 11 to be accurately provided at a prescribed position. Accordingly, generation of a defective image and the like can be suppressed and a higher quality solid-state image pickup device can be relatively easily obtained. Note that the mark 41 can be in any form such as a recess or protrusion as long as it shows the position of the transparent substrate 11. The mark 41 is not limited to the form shown in FIG. 1A.

For example, the transparent member 11 may be made of a glass material such as crown glass, borosilicate crown glass, heavy crown glass, light flint glass, flint glass, heavy flint glass, and fused quartz, a crystal material such as rock crystal and alumina, or a resin material such as epoxy, acrylic, polycarbonate, polyethylene, polyolefin, and polystyrene. The transparent member 11 preferably has a thickness of 0.3 nm to 0.7 mm. However, the thickness of the transparent member 11 is not limited to this range.

FIG. 2 is a cross-sectional view of a package structure of the solid-state image pickup device 1 of this embodiment. As shown in FIG. 2, the solid-state image pickup device 1 of this embodiment is mounted on a substrate 46, and is covered by a light-shielding resin 44 from the top surface of the substrate 46 to the top surface of the semiconductor substrate 14 and the respective side surfaces of the transparent adhesive layer 13 and the transparent member 11. This structure prevents light other than light from the top surface of the transparent member 11 from getting inside. For example, unnecessary charges are generated when light that is obliquely incident on the semiconductor substrate 14 is incident on signal lines and the like in a region other than the image pickup region. In this embodiment, however, the light-shielding resin 44 prevents such oblique incidence of light, whereby such generation of unnecessary charges is prevented. As a result, an optical device capable of further suppressing generation of a defective image can be implemented.

FIG. 2 shows an example of a surface mount type package structure in which the electrode pads 32 are respectively connected to inner leads 43 formed on the substrate 42 through thin metal wires 42 and external terminals 45 are formed by, e.g., solder balls. However, the invention is not limited to this structure. For example, a mold type package structure with a lead frame may be used such as SOP (Small Outline Package), QFP (Quad Flat Package), SON (Small Outline Non-leaded Package), and QFN (Quad Flat Non-leaded Package), or an LCC (Leaded Chip Carrier) type package structure (a ceramic package having a molded light-shielding resin 44) may be used.

### Second Embodiment

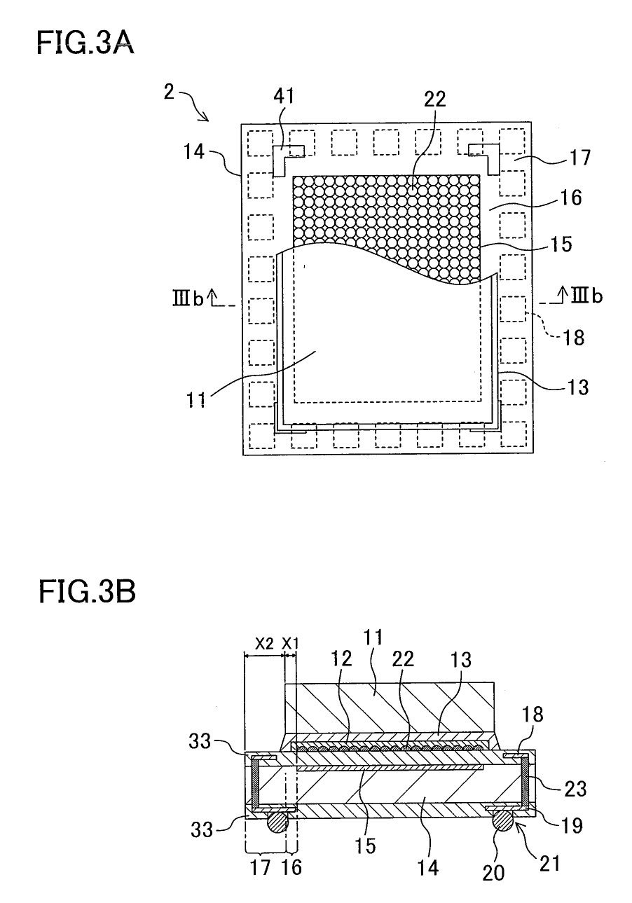

Hereinafter, the structure of a solid-state image pickup device 2 according to a second embodiment of the invention will be described with reference to FIGS. 3A and 3B. FIG. 3A is a top view of the structure of the solid-state image pickup device 2 of the embodiment. FIG. 3B is a cross-sectional view taken along line IIIb-IIIb in FIG. 3A.

As shown in FIGS. 3A and 3B, the solid-state image pickup device 2 of this embodiment includes a solid-state image pickup element, back wirings 19, electrically conductive electrodes 20, and electric conductors 23. The solid-state image pickup element includes a semiconductor substrate 14, an image pickup region 15, a microlens 22, a peripheral circuit region 16, and a plurality of terminals (pads) 18. The image pickup region 15 is provided on a main surface of the semiconductor substrate 14 and outputs a signal according to incident light. The microlens 22 is provided over the image pickup region 15 and collects external light onto the image pickup region 15. The peripheral circuit region 16 is provided around the image pickup region 15 and transmits a signal received from the image pickup region 15 to an external circuit. The plurality of terminals (pads) 18 are provided in a terminal region 17 and output a signal transmitted through the peripheral circuit region 16 to the external circuit. The back wirings 19 are formed over the back surface of the semiconductor substrate 14. Each electrically conductive electrode 20 is formed in a corresponding land 21 that exposes a part of the corresponding back wiring 19, and is connected to the corresponding back wiring 19. Each electric conductor 23 extends through the semiconductor substrate 14 and connects the corresponding terminal 18 to the corresponding back wiring 19. The main surface and the back surface of the semiconductor substrate 14 are covered by an insulating film 33. The solid-state image pickup device 2 further includes a low refractive index layer 12, a transparent member 11, and a transparent adhesive layer 13. The low refractive index layer 12 is provided on the microlens 22 so as to cover the image pickup region 15, and is made of a material having a lower refractive index than the microlens 22. The transparent member 11 is provided over the low refractive index layer 12 so as to cover the image pickup region 15. The transparent adhesive layer 13 bonds the semiconductor substrate 14 and the low refractive index layer 12 with the transparent member 11.

As shown in FIG. 3B, the transparent member 11 is formed so that the end face of the transparent member 11 is located between the image pickup region 15 and the terminal 18 when viewed two-dimensionally. The distance X1 between the end face of the transparent member 11 and the image pickup region 15 is 0.04 mm or more, and the distance X2 between the end face of the transparent member 11 and the end face of the semiconductor substrate 14 is 0.02 mm or more. As shown in FIG. 3A, a mark 41, for example, is formed over the main surface of the semiconductor substrate 14 in order to position the transparent member 11 at a prescribed location in view of these dimensions.

Like the solid-state image pickup device 1 of the first embodiment, the solid-state image pickup device 2 of this embodiment is characterized in that the transparent member 11 is formed so as to cover the image pickup region 15 and in that the transparent member 11 is bonded to the semiconductor substrate 14 so that the end face of the transparent member 11 is located at least 0.04 mm away from the image pickup region 15. This structure prevents chippings of the outer periphery of the transparent member 11 from affecting an image and therefore suppresses generation of a defective image. As a result, a smaller solid-state image pickup device with higher image quality than the conventional device can be implemented.

Unlike the electrode pads 32 of the solid-state image pickup device 1 of the first embodiment, the terminals 18 connected to an external circuit are not exposed in the solid-state image pickup device 2 of this embodiment. Therefore, the influence of adhesive overflow need not be considered. Accordingly, the distance between the transparent member 11 and the terminals 18 can be reduced, whereby a smaller solid-state image pickup device can be obtained as compared to the solid-state image pickup device 1 of the first embodiment.

Moreover, the transparent member 11 is provided at least 0.02 nm away from the end face of the semiconductor substrate 14. Therefore, the transparent adhesive layer 13 for bonding the transparent member 11 is less subjected to the influence of chippings of the semiconductor substrate 14 produced in a dicing step. As a result, an optical device capable of providing a higher quality image can be implemented.

For example, the transparent member 11 may be made of a glass material such as crown glass, borosilicate crown glass, heavy crown glass, light flint glass, flint glass, heavy flint glass, and fused quartz, a crystal material such as rock crystal and alumina, or a resin material such as epoxy, acrylic, polycarbonate, polyethylene, polyolefin, and polystyrene. The transparent member 11 preferably has a thickness of 0.3 nm to 0.7 mm. However, the thickness of the transparent member 11 is not limited to this range.

For example, solder balls may be used as the electrically conductive electrodes 20. Alternatively, resin balls having an electrically conductive coating film formed on the surface may be used as the electrically conductive electrodes 20. For the solder balls, materials having various compositions may be used such as a tin-silver-copper (Sn—Ag—Cu) based material, a tin-silver-bismuth (Sn—Ag—Bi) based material, and a zinc-bismuth (Zn—Bi) based material. In the case where the solder balls are used as the electrically conductive electrodes 20, the solid-state image pickup device 2 can be mounted on a circuit substrate by soldering or an electrically conductive adhesive. Similarly, in the case where the electrically conductive resin balls are used as the electrically conductive electrodes 20, the solid-state image pickup device 2 can be mounted on a circuit substrate by soldering or an electrically conductive adhesive.

In the solid-state image pickup device 2 of this embodiment, the mark 41 for positioning the transparent member 11 is formed over the semiconductor substrate 14. This enables the transparent substrate 11 to be accurately provided at a prescribed position. Accordingly, generation of a defective image and the like can be suppressed and a higher quality solid-state image pickup device can be relatively easily obtained. Note that the mark 41 can be in any form such as a recess or protrusion as long as it shows the position of the transparent substrate 11. The mark 41 is not limited to the form shown in FIG. 3A.

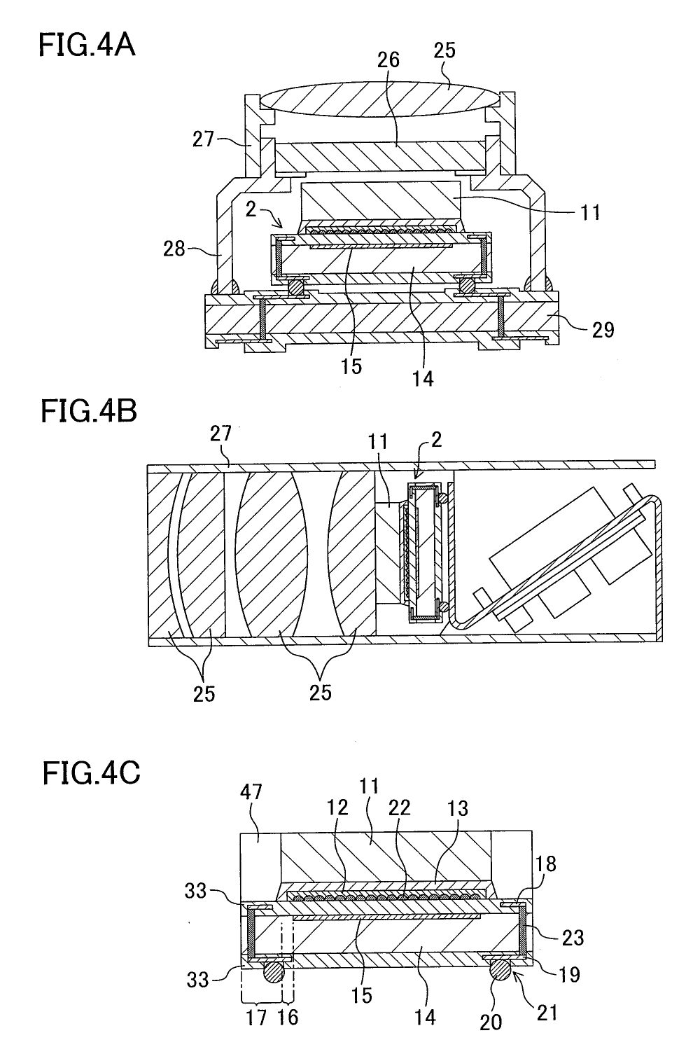

Examples of mounting the solid-state image pickup device 2 of this embodiment in various equipments will now be described. FIG. 4A is a cross-sectional view of the structure of a camera module having the solid-state image pickup device of this embodiment mounted thereon. As shown in FIG. 4A, the camera module of this embodiment includes a lens 25 for collecting external light onto the image pickup region 15, an optical component 26 provided between the lens 25 and the solid-state image pickup device 2, and a wiring substrate 29 connected to the solid-state image pickup device 2. Note that the lens 25 and the optical component 26 are surrounded by a barrel 27, and the solid-state image pickup device 2 is surrounded by a chamber 28. The camera module of this embodiment having the above structure includes the solid-state image pickup device 2 of this embodiment. Therefore, a small camera module capable of providing a high quality image can be implemented.

FIG. 4B is a cross-sectional view of a medical endoscope having the solid-state image pickup device 2 of this embodiment mounted therein. As shown in FIG. 4B, the medical endoscope of this embodiment includes a barrel 27, the solid-state image pickup device 2 of this embodiment provided in the barrel 27, and a plurality of lenses 25 for collecting external light onto the image pickup region of the solid-state image pickup device 2. The medical endoscope of this embodiment having the above structure includes the solid-state image pickup device 2 of this embodiment. Therefore, a small medical endoscope capable of providing a high quality image can be implemented.

Although not shown in the figures, a high quality, small digital camera can be implemented by mounting the solid-state image pickup device 2 of this embodiment on a digital still camera. Moreover, a high quality camera phone can be provided by mounting the solid-state image pickup device 2 of this embodiment on a mobile phone.

FIG. 4C is a cross-sectional view showing an example of a package structure of the solid-state image pickup device 2 of this embodiment. As shown in FIG. 4C, the solid-state image pickup device 2 of this embodiment is covered by a light-shielding resin 47 from the top surface of the semiconductor substrate 14 to the respective side surfaces of the transparent adhesive layer 13 and the transparent member 11. This structure prevents light other than light from the top surface of the transparent member 11 from getting inside. For example, unnecessary charges are generated when light that is obliquely incident on the semiconductor substrate 14 is incident on signal lines and the like in a region other than the image pickup region. In this embodiment, however, the light-shielding resin 47 prevents such oblique incidence of light, whereby such generation of unnecessary charges is prevented. As a result, an optical device capable of further suppressing generation of a defective image can be implemented.

As has been described above, the optical device, camera module, mobile phone, and medical endoscope according to the invention are useful for quality improvement and size reduction of various equipments having an optical device.

What is claimed is:

1. An optical device, comprising:
an optical element including a semiconductor substrate, an image pickup region provided on a main surface of the semiconductor substrate for outputting a signal according to incident light, a peripheral circuit region provided around the image pickup region for transmitting a signal received from the image pickup region, and a pad provided on a part of an edge of the main surface of the semiconductor substrate for outputting a signal transmitted through the peripheral circuit region; and
a transparent member bonded to the semiconductor substrate so that the transparent member covers the image pickup region and that an end face of the transparent member is located between the pad and the image pickup region when viewed two-dimensionally, wherein a distance between the end face and the image pickup region is 0.04 mm or more.

2. The optical device according to claim 1, wherein a distance between the end face of the transparent member and an end face of the semiconductor substrate is 0.02 mm or more.

3. The optical device according to claim 1, further comprising a transparent adhesive layer for bonding the semiconductor substrate to the transparent member.

4. The optical device according to claim 1, further comprising:
a wiring substrate provided under the semiconductor substrate; and
a thin metal wire for electrically connecting the pad to the wiring substrate, wherein a distance between the end face of the transparent member and the pad is 0.01 mm or more.

5. The optical device according to claim 2, further comprising:
an electrically conductive electrode provided over a back surface of the semiconductor substrate; and
an electric conductor plug extending through the semiconductor substrate for electrically connecting the pad with the electrically conductive electrode.

6. The optical device according to claim 1, wherein a mark for positioning the transparent member is formed over the semiconductor substrate.

7. The optical device according to claim 1, further comprising a light-shielding resin layer formed over a side surface of the transparent member from a top surface of the semiconductor substrate.

8. The optical device according to claim 1, wherein a planar outer shape of the semiconductor substrate is quadrilateral, the pad is provided on at least one side of the semiconductor substrate, and a distance between the end face of the transparent member and an end face of the semiconductor substrate is 0.02 mm or more on a side of the semiconductor substrate in which the pad is not provided.

9. A camera module, comprising:
an optical device including an optical element and a transparent member, wherein the optical element includes a semiconductor substrate, an image pickup region provided on a main surface of the semiconductor substrate for outputting a signal according to incident light, a peripheral circuit region provided around the image pickup region for transmitting a signal received from the image pickup region, and a pad provided on a part of an edge of the main surface of the semiconductor substrate for outputting a signal transmitted through the peripheral circuit region, the transparent member is bonded to the semiconductor substrate so that the transparent member covers the image pickup region and that an end face of the transparent member is located between the pad and the image pickup region when viewed two-dimensionally, and a distance between the end face and the image pickup region is 0.04 mm or more, the camera module further comprising:
a lens for collecting external light onto the image pickup region.

10. A mobile phone, comprising:
an optical device including an optical element and a transparent member, wherein the optical element includes a semiconductor substrate, an image pickup region provided on a main surface of the semiconductor substrate for outputting a signal according to incident light, a peripheral circuit region provided around the image pickup region for transmitting a signal received from the image pickup region, and a pad provided on a part of an edge of the main surface of the semiconductor substrate for outputting a signal transmitted through the peripheral circuit region, the transparent member is bonded to the semiconductor substrate so that the transparent member covers the image pickup region and that an end face of the transparent member is located between the pad and the image pickup region when viewed two-dimensionally, and a distance between the end face and the image pickup region is 0.04 mm or more, the mobile phone further comprising:
a lens for collecting external light onto the image pickup region.

11. A digital still camera, comprising:
an optical device including an optical element and a transparent member, wherein the optical element includes a semiconductor substrate, an image pickup region provided on a main surface of the semiconductor substrate for outputting a signal according to incident light, a peripheral circuit region provided around the image pickup region for transmitting a signal received from the image pickup region, and a pad provided on a part of an edge of the main surface of the semiconductor substrate for outputting a signal transmitted through the peripheral circuit region, the transparent member is bonded to the semiconductor substrate so that the transparent member covers the image pickup region and that an end face of the transparent member is located between the pad and the image pickup region when viewed two-dimensionally, and a distance between the end face and the image pickup region is 0.04 mm or more, the digital still camera further comprising:
a lens for collecting external light onto the image pickup region.

12. A medical endoscope, comprising:
a barrel;
an optical device provided in the barrel and including an optical element and a transparent member, wherein the optical element includes a semiconductor substrate, an image pickup region provided on a main surface of the semiconductor substrate for outputting a signal according to incident light, a peripheral circuit region provided around the image pickup region for transmitting a signal received from the image pickup region, and a pad provided on a part of an edge of the main surface of the semiconductor substrate for outputting a signal transmitted through the peripheral circuit region, the transparent member is bonded to the semiconductor substrate so that the transparent member covers the image pickup region and that an end face of the transparent member is located between the pad and the image pickup region when viewed two-dimensionally, and a distance between the end face and the image pickup region is 0.04 mm or more, the medical endoscope further comprising:
a lens provided in the barrel.
